(19) United States
(12) Patent Application Publication
(10) Pub. No.: US 2016/0088608 A1
(43) Pub. Date: Mar. 24, 2016

(54) RADIO COMMUNICATION POLICY ALLOCATION IN A NETWORK NODE

(71) Applicant: Telefonaktiebolaget L M Ericsson (publ), Stockholm (SE)

(72) Inventors: Bengt Lindoff, Bjarred (SE); Leif Wilhelmsson, Dalby (SE)

(73) Assignee: Telefonaktiebolaget L M Ericsson (publ), Stockholm (SE)

(21) Appl. No.: 14/786,970

(22) PCT Filed: Apr. 30, 2013
(86) PCT No.: PCT/EP2013/058944

§ 371 Date: Oct. 24, 2015

(51) Int. Cl. H04W 72/04

(52) U.S. Cl. CPC H04W 72/048; H04W 72/0413

(57) ABSTRACT

The present disclosure relates to a method in a network node of a communication network. The method comprises determining from signalling with a cellular RAN and/or a wireless transceiver whether a radio device is within range of said wireless transceiver or not. The radio device is connected to the communication network over the cellular RAN. The method also comprises allocating a first communication policy to the radio device for communication over the cellular RAN if said radio device has been determined to be within range of the wireless transceiver, or allocating a second communication policy, different than the first communication policy, to the radio device for communication over the cellular RAN if said radio device has been determined to not be within range of the wireless transceiver. The method further comprises sending a communication policy message to the cellular RAN, comprising the allocated communication policy for the radio device for communication over the cellular RAN.

### TECHNICAL FIELD

The present disclosure relates to methods and devices for allocating a radio communication policy to a radio device.

### BACKGROUND

In order to achieve high mobile broadband performance, heterogeneous networks, a mix of small pico/femto cells and large macro cells, are deployed. Such deployment might be beneficial in urban areas where the cost of the small cell deployment is small in relation to the benefit. In rural areas, however, such a solution might not be cost efficient. However, there is still a need to have good local hot spots in rural areas (for instance home mobile broadband access), while outside the hot spot/home the performance need only be moderate. Currently, rural areas are only covered by macro cells, and no hot spots are available.

WO 2012/073250 discloses a method for providing context based services in a smart environment. The method comprises: obtaining a user identification code corresponding to a user of a cellular mobile device present in the smart environment, wherein the user identification code is one of an international mobile subscriber identity (IMSI) number and an international mobile equipment identity (IMEI) number; and providing the at least one context based service to the user based on the obtaining. The method further comprises: determining attributes of a plurality of base transceiver stations serving in a predefined area; creating a virtual cell around a virtual base transceiver station associated with the smart environment, wherein the virtual base transceiver station has attributes different from the attributes of the plurality of base transceiver stations; and transmitting the attributes corresponding to the virtual base transceiver station for a predetermined time interval. Thus, the document discloses a method where a virtual cellular cell is broadcasting a signal in the cellular spectrum. Once a device detects that cell and tries to connect to it (using its IMSI) the IMSI is sent to the true cell and the virtual cell is closed down, but the system now knows that the device is in a specific area. Then specific service content is sent to the device. The document provides a way of enabling sending specific service content to a cellular mobile device depending on detecting the location of the cellular mobile device, but does not solve the need for providing a hot spot without deploying a heterogeneous network.

### SUMMARY

In accordance with the present disclosure, the ability to do communication restriction to a network (NW) node based on radio device location is introduced, regardless of cell coverage. For instance, once a device is in proximity of a wireless transceiver, e.g. having coverage within a building/house or the like, the radio device (or the wireless transceiver) reports the proximity of the radio device to the NW which then sets a first communication policy, e.g. a first set of communication restrictions, for the radio device. Once the proximity fails, e.g. because the radio device moves out of range of the wireless transceiver or because a timer expires, the NW communication with the radio device continues with a second communication policy, e.g. a second set of communication restrictions. The restrictions may for instance be which radio access technology (RAT) to use, throughput restrictions, setting of DRX cycles, the carrier frequency to use, connected state restrictions for instance as the transmission mode to use, etc.

According to an aspect of the present disclosure, there is provided a method in a network node of a communication network. The method comprises determining, from signalling with over cellular radio access network (RAN) and/or with a wireless transceiver, whether a radio device is within range of said wireless transceiver or not. The radio device is connected to the communication network over the cellular RAN. The method also comprises allocating a first communication policy to the radio device for communication over the cellular RAN if said radio device has been determined to be within range of the wireless transceiver. Alternatively, the method also comprises allocating a second communication policy, different than the first communication policy, to the radio device for communication over the cellular RAN if said radio device has been determined to not be within range of the wireless transceiver. The method also comprises sending a communication policy message to the radio device (2) over the cellular RAN, comprising information relating to the allocated communication policy for the radio device for communication over the cellular RAN. The communication policy message thus comprises the first or the second communication policy depending on which of the first and second communication policies has been allocated.

According to another aspect of the present disclosure, there is provided a network node for a communication network. The network node comprises communication circuitry enabled for signalling over a cellular RAN and/or with a wireless transceiver. The network node also comprises processor circuitry and a storage unit storing instructions that, when executed by the processor circuitry, cause the node to determine from signalling over the cellular RAN and/or with the wireless transceiver whether a radio device is within range of said wireless transceiver or not. The radio device is connected to the communication network over the cellular RAN. The instructions also cause the network node to allocate a first communication policy to the radio device for communication over the cellular RAN if said radio device has been determined to be within range of the wireless transceiver, or allocate a second communication policy, different than the first communication policy, to the radio device for communication over the cellular RAN if said radio device has been determined to not be within range of the wireless transceiver. The instructions also cause the network node to send a communication policy message to the radio device (2) over the cellular RAN, comprising information relating to the allocated communication policy for the radio device for communication over the cellular RAN.

According to another aspect of the present disclosure, there is provided a computer program product comprising computer-executable components for causing a network node to perform an embodiment of a method of the present disclosure when the computer-executable components are run on processor circuitry comprised in the network node.

According to another aspect of the present disclosure, there is provided a computer program comprising computer program code which is able to, when run on processor circuitry in a network node, cause the network node to determine from signalling over a cellular RAN and/or with a wireless transceiver whether a radio device is within range of said wireless transceiver or not. The radio device is connected to the communication network over the cellular RAN. The code is also able to cause the network node to allocate a first communication policy to the radio device for communication over the cellular RAN if said radio device has been determined to be within range of the wireless transceiver, or allocate a second communication policy, different than the first communication policy, to the radio device for communication over the cellular RAN if said radio device has been determined to not be within range of the wireless transceiver. The code is also able to cause the network node to send a communication policy message to the radio device (2) over the cellular RAN, comprising information relating to the allocated communication policy for the radio device for communication over the cellular RAN.

According to another aspect of the present disclosure, there is provided a computer program product comprising an embodiment of a computer program of the present disclosure and a computer readable means on which the computer program is stored.

According to another aspect of the present disclosure, there is provided a method in a radio device. The radio device is connected to a communication network via a cellular RAN. The method comprises receiving a first radio message from a wireless transceiver. The first radio message comprises an indicator for allocating a communication policy to said radio device for communication over the cellular RAN. The method also comprises sending a second radio message to the communication network over the cellular RAN. The second radio message comprises the indicator from the wireless transceiver, thereby indicating to the communication network that the radio device is in range of the wireless transceiver and that said allocating a communication policy should be done based on the radio device being in range of the wireless transceiver.

According to another aspect of the present disclosure, there is provided a method in a wireless transceiver. The wireless transceiver is connected to a communication network. The method comprises receiving a first radio message from a radio device connected to the communication network over a cellular RAN. The first radio message comprises an indicator for allocating a communication policy to said radio device for communication over the cellular RAN. The method also comprises sending a second radio message to the communication network. The second radio message comprises the indicator from the radio device, thereby indicating to the communication network that the radio device is in range of the wireless transceiver and that said allocating a communication policy should be done based on the radio device being in range of the wireless transceiver.

It is an advantage with embodiments of the present disclosure that they allow setting a different communication policy within a local area of a cell compared with the rest of the cell. Such communication policy can be used e.g. for optimizing the capacity usage (load balancing) of the entire NW including several RATs, optimizing trade-off between radio device power consumption and performance, as well as the pricing and performance of a particular subscription. For instance, a subscription may allow high performance mobile broadband at home, but only limited performance outside the home, or the like.

It is also made possible to allow high bit rate in certain areas without the need to densify the network. It might be seen as a virtual heterogeneous network obtained by only using one type of cells, typically macro cells. The performance of a cell (e.g. bandwidth) can be reduced in parts of the cell in order to allow increased performance in other part(s) of the cell, e.g. hot spots.

Generally, all terms used in the claims are to be interpreted according to their ordinary meaning in the technical field, unless explicitly defined otherwise herein. All references to “a/an/the element, apparatus, component, means, to step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

Embodiments will be described, by way of example, with reference to the accompanying drawings, in which:

FIG. 1 is a schematic illustration of a communication system including a communication network in accordance with an embodiment of the present disclosure.

FIG. 2 is a schematic block diagram of an embodiment of a network node of the present disclosure.

FIG. 3 is a schematic block diagram of an embodiment of a radio device or wireless transceiver of the present disclosure.

FIG. 4 is a schematic flow chart of an embodiment of a method of the present disclosure.

FIG. 5 is a schematic illustration of an embodiment of a computer program product of the present disclosure.

FIG. 6 is a is a schematic illustration of a communication system including a communication network in accordance with an example embodiment of the present disclosure.

FIG. 7 is a schematic flow chart of an example embodiment of a method of the present disclosure.

### DETAILED DESCRIPTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

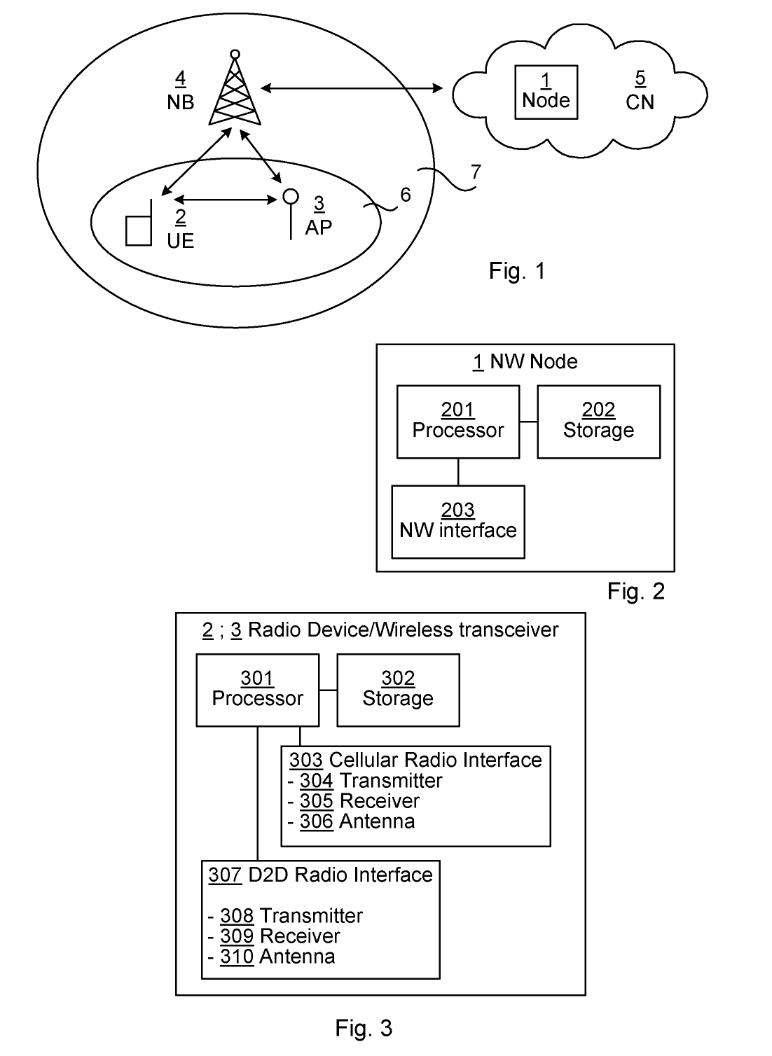

FIG. 1 schematically illustrates different parts/devices of the present disclosure and how they may interact with each other. A wireless transceiver 3, e.g. a Bluetooth or WLAN access point (AP), has a range 6 covering a geographical area (or volume). A radio device 2, e.g. a user equipment (UE), is connected to communication network 5 (in FIG. 1 represented by a core network (CN) 5), via a cellular RAN 4, in FIG. 1 represented by a 3^{rd} Generation Partnership Project (3GPP) Node B (NB). The cellular RAN comprises a plurality of cells 7, of which one for the RAN node (NB) is shown in FIG. 1. As discussed herein, the range 6 of the wireless transceiver 3 covers a part of the cell 7, e.g. forming a hot spot within a macro cell 7 served by the cellular RAN 4. The radio device may be any device or UE, mobile or stationary, enabled to communicate over a radio cannel in a communications network, for instance but not limited to e.g. mobile phone, smart phone, modem, sensors, meters, vehicles, household appliances, medical appliances, media players, cameras, or any type of consumer electronic, for instance but not limited to television, radio, lighting arrangements, tablet computer, laptop, or personal computer (PC). In accordance with the present disclosure, the communication network 5 is made aware when the radio device 2 gets within the range 6 of the wireless transceiver 3. As discussed herein, this may be e.g. by the radio device 2 or the wireless transceiver 3 sending a message to the communication network 5 via the cellular RAN 4. The communication network 5 comprises a network node 1 which in accordance with the present disclosure is responsible for determining whether the radio device 2 is or has been in range 6 of the wireless transceiver 3 and for allocating a first or second communication policy to the radio device 2 depending on whether it is within the range 6 or not.

In some embodiments of the present disclosure, the first communication policy restricts radio resources available to the radio device to give a first bandwidth, and the second communication policy restrict radio resources available to the radio device 2 to give a second bandwidth, the first bandwidth being larger than the second bandwidth. Thus, the bandwidth available to the radio device 2 for e.g. data traffic is higher when the radio device has been determined to be within the range 6 (i.e. in a hot spot) than when the radio device is not within the range 6. The bandwidth may be considered as an amount of transmission resources, e.g. allocated bandwidth in a 3GPP LTE system such as 5, 10 or 20 MHz or carrier aggregation such as 10+10 or 20+20 MHz, or throughput in sense of average rate of successful message delivery over a communication channel. Bandwidth is one property which the communication policies may regulate. However, also other restrictions may restrict radio resources to indirectly regulate the bandwidth, e.g. Radio Access Technology (RAT) such as 3GPP Long Term Evolution (LTE), Wideband Code Division Multiple Access (WCDMA)/High Speed Packet Access (HSPA) or Global System for Mobile Communications (GSM)/General packet radio service (GPRS)/Enhanced GPRS (EGPRS)/Enhanced Data rates for GSM Evolution (EDGE); scheduling discontinuous reception (DRX) cycles etc. In some embodiments of the present disclosure, the radio resources which are restricted are data traffic resources.

In some embodiments of the present disclosure, the first and second communication policy include at least one restriction which is different in the first communication policy compared with the second communication policy, said at least one restriction specifying the bandwidth or data rate allowed; the scheduling allowed; the discontinuous reception, DRX, cycles allowed; transmission mode(s) allowed; or the radio access technology, RAT, allowed to the radio device (2) for communication over the cellular RAN. As mentioned above, these are examples of restrictions which may regulate the bandwidth available to the radio device 2, but also other properties than the bandwidth may be regulated.

In some embodiments of the present disclosure, the first and/or second communication policy depends on the time at which the allocating a first/second communication policy occurs. The first communication policy, e.g. in a hot spot, may e.g. depend on the time of day or week such that e.g. a higher bandwidth/data rate is made available in the hot spot to the radio device 2 at night when there is generally low traffic in the cell 7 and thus more resources can be directed to the hot spot defined by the range 6. Similarly, the second communication policy may e.g. depend on the time of day or week such that e.g. a higher bandwidth/data rate is made available e.g. during office hours when a home hot spot is not expected to require much resources.

In some embodiments of the present disclosure, the allocating a first communication policy comprises allocating said first communication policy to the radio device 2 for as long as the radio device is in range 6 of the wireless transceiver 3. Thus, the first communication policy is used for the radio device 2 as long as it is indicated to the NW node 1 that the radio device is within a hot spot as defined by the range 6. For example, the radio device 2 or the wireless transceiver 3 may periodically send an indication that the radio device 2 is within the range 6 for as long as the radio device is within range of the wireless transceiver 3, to the communication network 5 via the cellular RAN 4. Thus, when such an indication is no longer periodically received by the network 5, the second communication policy is allocated to the radio device.

In some embodiments of the present disclosure, the allocating a first communication policy comprises allocating said first communication policy to the radio device 2 during a predefined time period starting from the determining that the radio device is within range 6 of the wireless transceiver 3. As an example, the allocating of the first communication policy can then start upon the radio device 2 passing the range 6 of a Bluetooth or radio frequency identification (RFID) transceiver 3 when entering e.g. a train or other means of transport in which e.g. improved wireless connection is provided during a trip. A timer may run from the determining that the radio device 2 is within range 6, or the improved connection may be between set time points (e.g. from 1 μm to 3 μm for a two hour train journey) after the determining that the radio device 2 is within range 6 e.g. when entering the train.

In some embodiments of the present disclosure, the wireless transceiver 3 is a Bluetooth transceiver; a wireless local area network (WLAN) transceiver; or a radio frequency identification (RFID) transceiver; using a radio communication technology for communicating with the radio device 2, which is different than a radio access technology (RAT) used by the cellular RAN 4. Thus, the wireless transceiver may not interfere with communication over the cellular RAN 4.

Alternatively, in some embodiments of the present disclosure, the wireless transceiver 3 is configured for communicating with the radio device 2 in network (NW) assisted device-to-device (D2D) communication, and the determining that the radio device 2 is within range 6 of the wireless transceiver 3 comprises determining whether the radio device 2 and the wireless transceiver 3 are in range for D2D communication, wherein the result of said determining is (only) used for the allocating of the first or second communication policy. The determining that the radio device 2 is in range for NW assisted D2D communication with the wireless transceiver 3 is one way of determining that the radio device is within the range 6 of the wireless transceiver 3. Actual D2D communication may not need to be set up. It may be sufficient to determine that the radio device 2 is in range for D2D communication, although some exchange of information via D2D communication may occur, at least one-way, in order for the radio device 2 and the wireless transceiver 3 to detect each other. Thus, the same RAT may be used, within existing D2D protocols, for determining whether the radio device 2 is within the range 6 as is used for communication via the cellular RAN 4.

In some embodiments, the wireless transceiver is a non-cellular wireless transceiver/access point.

In some embodiments of the present disclosure, the determining whether a radio device is within range 6 of a wireless transceiver 3 comprises receiving a message from the wireless transceiver indicating that the radio device is within range of the wireless transceiver. This is one way of informing the network 5 of the radio device 2 being within the range 6. The wireless transceiver 3 may detect the radio device 2 and e.g. obtain the media access control (MAC) address or other identifier or indicator of the radio device 2. The wireless transceiver may then forward the identifier in said message e.g. via the cellular RAN 4, thereby indicating to the network node 1 that the radio device 2 is within the range 6.

Additionally or alternatively, in some embodiments of the present disclosure, the determining that a radio device 2 is within range of a wireless transceiver 3 comprises receiving a message from the radio device indicating that it is within range of the wireless transceiver. This is another way of informing the network 5 of the radio device 2 being within the range 6. The radio device 2 may detect the wireless transceiver and e.g. obtain the media access control (MAC) address or other identifier or indicator of the wireless transceiver 3. The radio device may then forward the identifier in said message e.g. via the cellular RAN 4, thereby indicating to the network node 1 that the radio device 2 is within the range 6.

FIG. 2 schematically illustrates an embodiment of a NW node 1 of the present disclosure. The NW node 1 comprises a processor/processor circuitry 201 e.g. a central processing unit (CPU). The processor 201 may comprise one or a plurality of processing units in the form of microprocessor(s). However, other suitable devices with computing capabilities could be comprised in the processor 201, e.g. an application specific integrated circuit (ASIC), a field programmable gate array (FPGA) or a complex programmable logic device (CPLD). The processor 201 is configured to run one or several computer program(s) or software stored in a storage unit 202 e.g. a memory. The storage unit is regarded as a computer readable means and may e.g. be in the form of a Random Access Memory (RAM), a Flash memory or other solid state memory, or a hard disk. The processor 201 is also configured to store data in the storage unit 202, as needed. The NW node 1 also comprises a network interface 203 for communication with other parts of the communication NW 5 and/or the cellular RAN 4.

FIG. 3 schematically illustrates a radio device 2 or a wireless transceiver 3 (in reference to FIG. 3 generally referred to as radio device 2; 3) of the present disclosure. The radio device 2; 3 comprises a processor/processor circuitry 301 e.g. a central processing unit (CPU). The processor 301 may comprise one or a plurality of processing units in the form of microprocessor(s). However, other suitable devices with computing capabilities could be comprised in the processor 301, e.g. an application specific integrated circuit (ASIC), a field programmable gate array (FPGA) or a complex programmable logic device (CPLD). The processor 301 is configured to run one or several computer program(s) or software stored in a storage unit 302 e.g. a memory. The storage unit is regarded as a computer readable means and may e.g. be in the form of a Random Access Memory (RAM), a Flash memory or other solid state memory, or a hard disk. The processor 301 is also configured to store data in the storage unit 302, as needed. The radio device 2, and optionally the wireless transceiver 3, comprises a radio interface 303 for communication over the cellular RAN 4. The cellular radio interface 303 comprises a transmitter 304, a receiver 305 and an antenna 306, which may be combined to form a transceiver or be present as distinct units within the radio device 2; 3. The transmitter 304 is configured to cooperate with the processor to transform data bits to be transmitted over an air interface to a suitable radio signal in accordance with the radio access technology (RAT) used by the Radio Access Network (RAN) 4 via which the data bits are to be transmitted. The receiver 305 is configured to cooperate with the processor 301 to transform a received radio signal to received data bits. The antenna 306 may comprise a single antenna or a plurality of antennas, e.g. for different frequencies and/or for MIMO (Multiple Input Multiple Output) communication. The antenna 306 is used by the transmitter 304 and the receiver 305 for transmitting and receiving, respectively, radio signals. Similarly, the radio device 2; 3 may comprise a radio interface 307 for communication with the wireless transceiver 3 or the radio device 2, respectively, here called a D2D radio interface 307. The D2D radio interface may be configured for communication via e.g. Bluetooth, RFID or NW assisted D2D RAT. The D2D radio interface 307 comprises a transmitter 308, a receiver 309 and an antenna 310, which may be combined to form a transceiver or be present as distinct units within the radio device 2; 3. The transmitter 308 is configured to cooperate with the processor to transform data bits to be transmitted over an air interface to a suitable radio signal in accordance with the radio access technology (RAT) used. The receiver 309 is configured to cooperate with the processor 301 to transform a received radio signal to received data bits. The antenna 310 may comprise a single antenna or a plurality of antennas, e.g. for different frequencies and/or for MIMO communication. The antenna 310 is used by the transmitter 308 and the receiver 309 for transmitting and receiving, respectively, radio signals.

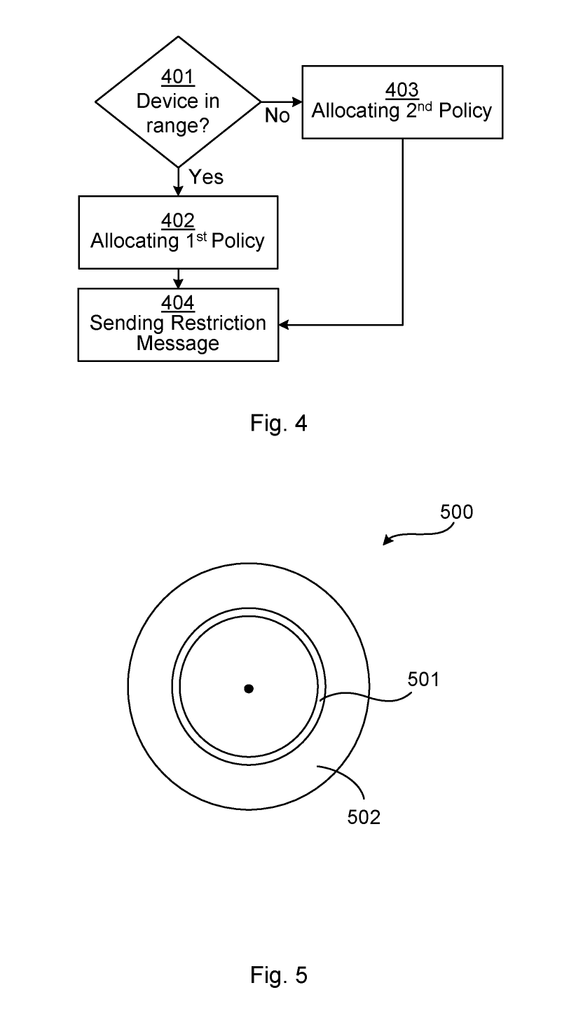

FIG. 4 is a schematic flow chart of an embodiment of a method of the present disclosure. The method is performed by/in the network node 1 in the communication network 5. The radio device 2 is determined 401 to be either within or out of range 6 of the wireless transceiver 3 by means of signalling with the cellular RAN 4 and/or the wireless transceiver 3. The radio device 2 is connected to the communication network over the cellular RAN 4. If the radio device has been determined 401 to be within range of the wireless transceiver 3, then a first communication policy is allocated 402 to the radio device 2 for communication over the cellular RAN. On the other hand, if the radio device has been determined 401 to not be within range of the wireless transceiver 3, then a second communication policy, different than the first communication policy, is allocated 403 to the radio device 2 for communication over the cellular RAN. Then, message including information related to the communication policy message is sent 404 over the cellular RAN, comprising information related to the allocated 402; 403 communication policy for the radio device 2 for communication over the cellular RAN. If the first communication policy is allocated 402, then the communication policy message will comprise said first communication policy, and similarly, if the second communication policy is allocated 403, then the communication policy message will comprise said second communication policy. The allocated communication policy may then be used by the radio device 2 for its communication over the cellular RAN 4.

FIG. 5 illustrates a computer program product 500. The computer program product 500 comprises a computer readable medium 502 comprising a computer program 501 in the form of computer-executable components 501. The computer program/computer-executable components 501 may be configured to cause a network node 1, a radio device 2 or a wireless transceiver 3, e.g. as discussed above, to perform an embodiment of a method of the present disclosure. The computer program/computer-executable components may be run on the processor 201 or 301 for causing the network node 1, radio device 2 or wireless transceiver 3, respectively, to perform the method. The computer program product 500 may e.g. be comprised in a storage unit or memory 202 or 302 comprised in the network node 1, radio device 2 or wireless transceiver 3 and associated with the processor 201 or 301. Alternatively, the computer program product 500 may be, or be part of, a separate, e.g. mobile, storage means, such as a computer readable disc, e.g. CD or DVD or hard disc/drive, or a solid state storage medium, e.g. a RAM or Flash memory.

### EXAMPLES

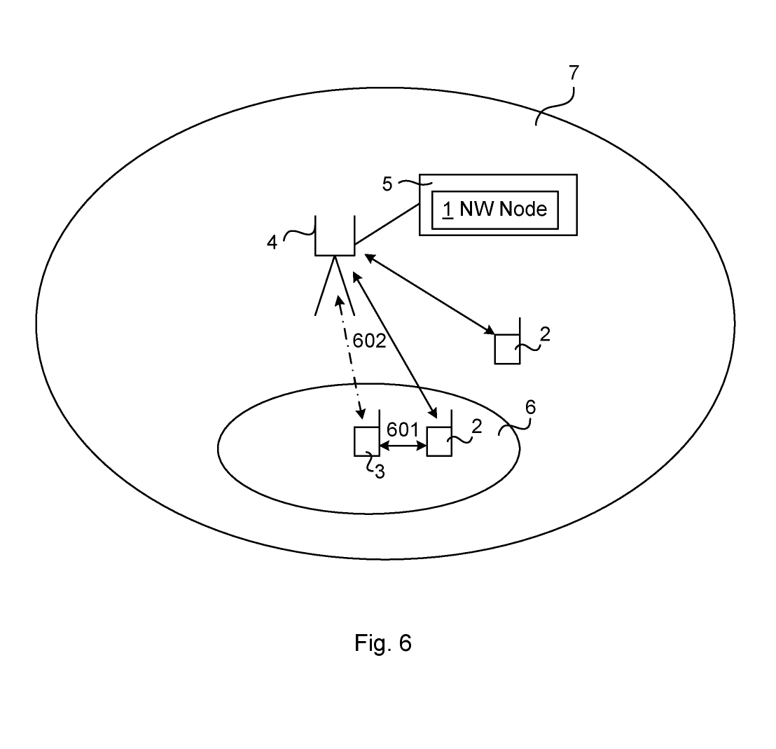

Exemplary embodiments of the present disclosure are illustrated by means of FIG. 6. A RAN node 4 has a first coverage area or cell 7. The RAN node 4 may support communication using several Radio Access Technologies (RAT) or communication on several carrier frequencies. Thus, the coverage area 7 may arguably comprise a plurality of cells depending on the terminology used. A radio device 2 is connected to the RAN node 4. The cellular RAN node 4 is in its turn connected to the communication NW 5 and the NW node 1. As long as the device is in proximity to the wireless transceiver 3, either the radio device 2 or the wireless transceiver 3 reports the proximity to the NW 5 (or to the RAN node 4) which then uses a first communication policy, e.g. a set of communication restrictions, in the communication between the RAN node 4 and the radio device 2. Once the connection or proximity between the radio device 2 and the wireless transceiver 3 is dropped or no longer possible, that is reported to the NW 5 (or the RAN node 4) which then continues the communication using a second communication policy or set of communication restriction.

### Example 1

In an embodiment it is intended to let the network 5 operator have control over the data rate provided to a radio device 2, but the provided data rate is determined by location (not by signal strength). A specific example is a subscription where the provided data rate when at home is, e.g., 80 Mbps and allow use of Long Term Evolution (LTE), but when away from home is limited to 2 Mbps. The identification that the radio device 2 is at home can then be made using a wireless transceiver 3 using for instance Bluetooth. The Bluetooth transceiver 3 broadcasts its device address or some other identity associated with the device and known to the NW node. The address may further be encrypted in order to make a secure communication. Once the radio device 2 can detect this broadcast address it connects and receives 601 an indicator specific for the wireless transceiver 3. This indicator is sent 602 to the network 5, e.g. to the NW node 1, and the network then knows that the radio device 2 is within the building. Once the network has this knowledge, the connection to radio device 2 will be made using the first communication policy (LTE, max 80 Mbits/s in this case). Also other wireless transceivers 3 like RFID, Wi-Fi/WLAN might be used instead of Bluetooth. A variation of the above theme is that the radio device 2 is only allowed to use a first subset of radio access technologies, e.g. LTE, at home and a second set of RATs, e.g. Wideband Code Division Multiple Access (WCDMA)/High Speed Data Access (HSPA), Global System for Mobile Communications (GSM)/GPRS/EGPRS, in other places covered by the NW 5 and the RAN 4 cells 7. By this approach, the operator has the possibility to control RAT usage even within a specific cell 7. In prior art techniques the inter RAT handover (IRAT HO) is only triggered at cell borders). The solution proposed in this example could be an advantage for instance for optimized RAT load balancing.

### Example 2

In an embodiment, the communication restriction may be in respect of which allowed DRX cycles to be used by the radio device 2. For instance, once the radio device 2 is at home (in proximity to the wireless transceiver 3) the radio device 2 or the wireless transceiver 3 reports 602 this to the NW 5 (or to the cellular RAN 4), e.g. to the NW node 1, which then knows that mobile broadband high performance is important. Hence the communication restriction in that case might be “use no DRX” or “use longer inactivation timers in active state”, in order for the radio device 2 to have a faster response time. Once not in proximity to the wireless transceiver 3, that is reported to the NW 5 (or to the RAN 4), e.g. to the NW node 1, which then reconfigures the connection to use longer DRX cycles and/or shorter inactivity timers for optimized power consumption performance.

### Example 3

In an embodiment, the communication restriction is in respect of which allowed DRX cycles to be used by the radio device 2. For instance once the device is plugged into a power charger, the radio device 2 or a wireless transceiver 3 attached to the power charger reports 602 this to the NW 5 (or to the cellular RAN 4), e.g. to the NW node 1, which then knows that power consumption might not be a big deal, but performance is. Hence the communication restriction in that case might be “use no DRX” or “use longer inactivation timers in active state”, in order to have faster response time. Once unplugged, that is reported to the NW 5 (or to the cellular RAN 4), e.g. to the NW node 1, which then reconfigures the connection to use longer DRX cycles and/or shorter inactivity timers for optimized power consumption performance.

### Example 4

In an embodiment, the communication restriction may be related to which carrier frequency to use. For instance, a first carrier is used for Mobile broadband at home (when the first communication policy is allocated), and a second carrier is used for mobility (outside home, when the second communication policy is allocated).

In other embodiments, the communication restriction may be related to for instance use transmission modes, use of MIMO transmission etc.

In an extended embodiment, the first communication policy is used from the detection and report of communication between the wireless transceiver 3 and the radio device 2 and a well-defined time after that time instant. After a timer has expired, the communication continues using the second communication policy.

In yet another extended embodiment, with the purpose of allowing the operator of the NW 5 to have better control, the data rate is limited by means of the second communication policy during rush hours, e.g. 6-9 am and 4-6 pm outside the range 6 of the wireless transceiver 3.

### Example 5

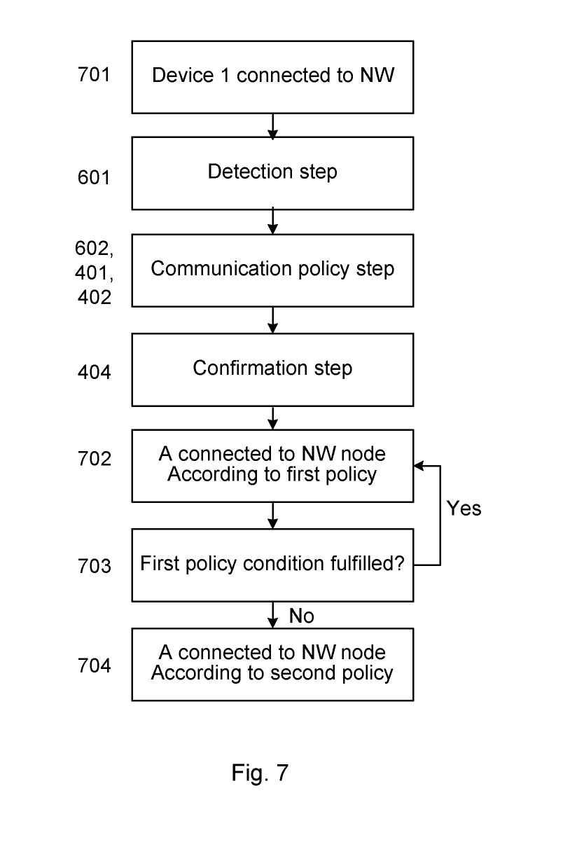

A generic flow chart over an embodiment of a method of the present disclosure can be seen in FIG. 7. A radio device 2 (UE, modem, sensor, tablet, smart-phone or the like) is connected 701 to a cellular RAN node 4 (Long Term Evolution (LTE)/High Speed Data Access (HSPA), Enhanced Data rates for Global System for Mobile Communications (GSM) Evolution (EDGE) or the like). Then there is a detection step, where the radio device 2 detects 601 a wireless transceiver 3 associated with a first set of communication restriction between radio device 2 and the NW 5, typically by receiving 601 a first radio message from the wireless transceiver 3. The detection 601 is done according to any of the examples above. Then a negotiation step is performed, where the NW node 1 of the NW 5 is informed 602 about that the radio device 2 is in proximity to the wireless transceiver 3, thus determining 401 that the radio device 2 is in range 6 of said wireless transceiver 3. Here, the NW node 1 also allocates 402 the first communication policy to the radio device 2, based on said radio device being within the range 6 of the wireless transceiver 3. Once a confirmation is made (may be for instance an text message (Short Message Service, SMS) or indicated by an icon in the display in case the device 2 have a display, the icon being related to the communication policy used) to the radio device 2 by sending 404 the communication policy message stating that the communication is made using communication according to the first communication policy, and is valid under certain conditions, as examples above. The radio device 2 is also informed by the NW 5 and configured to fulfil the first communication policy, e.g. a first set of communication restrictions, (i.e. configures allowed carrier frequencies, allowed RATs, used DRX cycles, transmission modes etc.). The communication between radio device 2 and the cellular RAN 4 is made using 702 the first communication policy as long as the conditions are fulfilled 703, e.g. as long as the radio device 2 is within the range 6 or as long as a timer has not expired. Once the condition is not fulfilled anymore the NW 5 is informed and the RAN 4 and the radio device 2 is configured to use 704 the second communication policy, e.g. second set of communication restrictions. Also, a text message to the radio device 2 might be sent, informing the user about the second communication policy (for instance, max 2 Mbits/s), or another icon is displayed in a display of the device 2, the icon being associated with the second communication policy.

Below follow some other aspects of the present disclosure.

According to another aspect of the present disclosure, there is provided a network node 1 of a communication network 5. The network node comprises means 301 for determining 401 from signalling over a cellular RAN 4 and/or with wireless transceiver 3 whether a radio device 2 is within range 6 of said wireless transceiver 3 or not, said radio device 2 being connected to the communication network over the cellular RAN 4. The network node also comprises means 301 for allocating 402 a first communication policy to the radio device 2 for communication over the cellular RAN if said radio device has been determined 401 to be within range of the wireless transceiver 3, or means 301 for allocating 403 a second communication policy, different than the first communication policy, to the radio device 2 for communication over the cellular RAN if said radio device has been determined 401 to not be within range of the wireless transceiver 3. The network node also comprises means 301, 303 for sending 404 a communication policy message to the radio device 2 over the cellular RAN, comprising information relating to the allocated 402; 403 communication policy for the radio device 2 for communication over the cellular RAN.

According to another aspect of the present disclosure, there is provided a radio device 2. The radio device comprises communication circuitry 303, 307 enabled for signalling with a cellular RAN 4 and a wireless transceiver 3. The radio device also comprises processor circuitry 301, and a storage unit 302 storing instructions that, when executed by the processor circuitry, cause the radio device to receive a first radio message from the wireless transceiver. The first radio message comprises an indicator for allocating a communication policy to said radio device for communication over the cellular RAN. The instructions also cause the radio device to send a second radio message to the communication network via the cellular RAN. The second radio message comprises the indicator from the wireless transceiver, thereby indicating to the communication network that the radio device is in range of the wireless transceiver and that said allocating a communication policy should be done based on the radio device being in range of the wireless transceiver.

According to another aspect of the present disclosure, there is provided a radio device 2. The radio device comprises means 307, 301 for receiving 601 a first radio message from a wireless transceiver 3, said first radio message comprising an indicator for allocating a communication policy to said radio device 2 for communication over a cellular RAN 4. The radio device also comprises means 303, 301 for sending 602 a second radio message to the communication network 5 over the cellular RAN 4, said second radio message comprising the indicator from the wireless transceiver 3, thereby indicating to the communication network that the radio device is in range 6 of the wireless transceiver and that said allocating a communication policy should be done based on the radio device being in range of the wireless transceiver.

According to another aspect of the present disclosure, there is provided a wireless transceiver 3. The wireless transceiver comprises communication circuitry 303, 307 enabled for signalling with a cellular RAN 4 and a radio device 2. The wireless transceiver also comprises processor circuitry 301, and a storage unit 302 storing instructions that, when executed by the processor circuitry, cause the wireless transceiver to receive a first radio message from the radio device, connected to the communication network via a cellular RAN. The first radio message comprises an indicator for allocating a communication policy to said radio device for communication over the cellular RAN. The instructions also cause the wireless transceiver to send a second radio message to the communication network. The second radio message comprises the indicator from the radio device, thereby indicating to the communication network that the radio device is in range of the wireless transceiver and that said allocating a communication policy should be done based on the radio device being in range of the wireless transceiver.

According to another aspect of the present disclosure, there is provided a wireless transceiver 3. The wireless transceiver comprises means 307, 301 for receiving a first radio message from a radio device 2, the radio device being connected to the communication network 5 over a cellular RAN 4, said first radio message comprising an indicator for allocating a communication policy to said radio device 2 for communication over the cellular RAN. The wireless transceiver also comprises means 303, 301 for sending a second radio message to the communication network 5, said second radio message comprising the indicator from the radio device 2, thereby indicating to the communication network that the radio device is in range 6 of the wireless transceiver and that said allocating a communication policy should be done based on the radio device being in range of the wireless transceiver.

The present disclosure has mainly been described above with reference to a few embodiments. However, as is readily appreciated by a person skilled in the art, other embodiments than the ones disclosed above are equally possible within the scope of the present disclosure, as defined by the appended claims.

1. A method in a network node of a communication network, the method comprising:
determining from signalling over a cellular radio access network (RAN) and/or with wireless transceiver whether a radio device is within range of said wireless transceiver or not, said radio device being connected to the communication network over the cellular RAN; and
allocating a first communication policy to the radio device for communication over the cellular RAN if said radio device has been determined to be within range of the wireless transceiver, or
allocating a second communication policy, different than the first communication policy, to the radio device for communication over the cellular RAN if said radio device has been determined to not be within range of the wireless transceiver; and
sending a communication policy message to the radio device over the cellular RAN, comprising information relating to the allocated communication policy for the radio device for communication over the cellular RAN.

2. The method of claim 1, wherein the first communication policy restricts radio resources available to the radio device to give a first bandwidth, and the second communication policy restrict radio resources available to the radio device to give a second bandwidth, the first bandwidth being larger than the second bandwidth.

3. The method of claim 2, wherein the radio resources which are restricted are data traffic resources.

4. The method of claim 1, wherein the first and second communication policy include at least one restriction which is different in the first communication policy compared with the second communication policy, said at least one restriction specifying the bandwidth allowed; the scheduling allowed; the discontinuous reception (DRX) cycles allowed; transmission mode(s) allowed; or the radio access technology (RAT) allowed to the radio device for communication over the cellular RAN.

5. The method of claim 1, wherein the second communication policy depends on the time at which the allocating a second communication policy occurs.

6. The method of claim 1, wherein the allocating a first communication policy comprises allocating said first communication policy to the radio device for as long as the radio device is in range of the wireless transceiver.

7. The method of claim 1, wherein the allocating a first communication policy comprises allocating said first communication policy to the radio device during a predefined time period starting from the determining that the radio device is within range of the wireless transceiver.

8. The method of claim 1, wherein the wireless transceiver is a Bluetooth transceiver; a wireless local area, network transceiver; or a radio frequency, identification (RFID) transceiver; using a radio communication technology for communicating with the radio device, which is different than a radio access technology used by the cellular RAN.

9. The method of claim 1, wherein the wireless transceiver is configured for communicating with the radio device in network assisted device-to-device (D2D) communication, and the determining comprises determining whether the radio device and the wireless transceiver are in range for D2D communication, wherein the result of said determining is used for the allocating of the first or second communication policy.

10. The method of claim 1, wherein said determining whether a radio device is within range of a wireless transceiver comprises receiving a message from the wireless transceiver indicating that the radio device is within range of the wireless transceiver.

11. The method of claim 1, wherein said determining whether a radio device is within range of a wireless transceiver comprises receiving a message from the radio device indicating that it is within range of the wireless transceiver.

12. A network node for a communication network, the node comprising:
communication circuitry enabled for signalling over a cellular radio access network (RAN) and/or with a wireless transceiver;
processor circuitry; and
a storage unit storing instructions that, when executed by the processor circuitry, cause the node to:
determine from signalling over the cellular RAN and/or with the wireless transceiver whether a radio device is within range of said wireless transceiver or not, said radio device being connected to the communication network over the cellular RAN; and
allocate a first communication policy to the radio device for communication over the cellular RAN if said radio device has been determined to be within range of the wireless transceiver, or
allocate a second communication policy, different than the first communication policy, to the radio device for communication over the cellular RAN if said radio device has been determined to not be within range of the wireless transceiver; and
send a communication policy message to the radio device over the cellular RAN, comprising information relating to the allocated communication policy for the radio device for communication over the cellular RAN.

13. (canceled)

14. A nontransitory computer readable medium comprising computer program code which, when run on processor circuitry in a network node, causes the network node to:
determine from signalling over a cellular radio access network (RAN) and/or with a wireless transceiver whether a radio device is within range of said wireless transceiver or not, said radio device being connected to the communication network over the cellular RAN; and
allocate a first communication policy to the radio device for communication over the cellular RAN if said radio device has been determined to be within range of the wireless transceiver, or
allocate a second communication policy, different than the first communication policy, to the radio device for communication over the cellular RAN if said radio device has been determined to not be within range of the wireless transceiver; and
send a communication policy message to the radio device over the cellular RAN, comprising information relating to the allocated communication policy for the radio device for communication over the cellular RAN.

15. (canceled)

16. A method in a radio device, the radio device being connected to a communication network via a cellular radio access network (RAN), the method comprising:
receiving a first radio message from a wireless transceiver, said first radio message comprising an indicator for allocating a communication policy to said radio device for communication over the cellular RAN; and
sending a second radio message to the communication network over the cellular RAN, said second radio message comprising the indicator from the wireless transceiver, thereby indicating to the communication network that the radio device is in range of the wireless transceiver and that said allocating a communication policy should be done based on the radio device being in range of the wireless transceiver.

17. A method in a wireless transceiver, the wireless transceiver being connected to a communication network, the method comprising:
receiving a first radio message from a radio device, connected to the communication network over a cellular radio access network (RAN), said first radio message comprising an indicator for allocating a communication policy to said radio device for communication over the cellular RAN; and
sending a second radio message to the communication network, said second radio message comprising the indicator from the radio device, thereby indicating to the communication network that the radio device is in range of the wireless transceiver and that said allocating a communication policy should be done based on the radio device being in range of the wireless transceiver.
